(19) United States
(12) Patent Application Publication
(10) Pub. No.: US 2024/0077371 A1
(43) Pub. Date: Mar. 7, 2024

(54) WALL SHEAR STRESS SENSOR AND SYSTEM

(71) Applicant: University of Newcastle upon Tyne, Newcastle upon Tyne, Tyne and Wear (GB)

(72) Inventors: Richard David Whalley, Newcastle upon Tyne, Tyne and Wear (GB); Nima Ebrahimzade, Newcastle upon Tyne, Tyne and Wear (GB); Peter Jonathan Cumpson, Newcastle upon Tyne, Tyne and Wear (GB)

(73) Assignee: University of Newcastle upon Tyne, Newcastle upon Tyne, Tyne and Wear (GB)

(21) Appl. No.: 18/272,198

(22) PCT Filed: Dec. 14, 2021
(86) PCT No.: PCT/GB2021/053278

§ 371 Date: Jul. 13, 2023

(30) Foreign Application Priority Data
Jan. 15, 2021 (GB) 2100565.7

(51) Int. Cl. G01L 1/24; G01B 11/16

(52) U.S. Cl. CPC G01L 1/24; G01B 11/16

(57) ABSTRACT

A wall shear stress sensor comprising first and second optical gratings, an incident light source and a photodetector. The second optical grating overlaps the first optical grating such that the first optical grating and second optical grating form a Moiré fringe pattern, wherein the second optical grating is displaceable relative to the first optical grating in response to a wall shear stress imparted on the sensor, and wherein displacement of the second optical grating correlates with a phase shift in the Moiré fringe pattern. The incident light source is configured to sequentially illuminate a plurality of discrete locations distributed across the Moiré fringe pattern. The photodetector is configured to detect light intensity reflected from each discrete location on the Moiré fringe pattern. A method of using the sensor and a two dimensional wall shear stress sensor system are also disclosed.

The present invention relates to a wall shear stress sensor. In particular, but not exclusively, the present invention relates to an optical micro-electro-mechanical system (MEMS) wall shear stress sensor and wall shear stress detector system.

### BACKGROUND

Knowledge of instantaneous wall shear stress is vital to deepen physical understanding of wall-turbulent flows. The ability to measure wall shear stress in both one and two dimensions over a surface area would be highly beneficial to the field of fluid dynamics and hence the development of more efficient aircraft or high-speed transportation, for example. Such sensors would also be useful, for example in wind tunnel operations, aerospace, both high performance and domestic automotive, and in the rail industry.

Some known wall shear stress sensors use a shift phase in a Moiré fringe pattern to measure wall shear stress. This has been carried out using optical methods, which have several advantages over the use of electrical sensors. For example, fibre optics are insensitive to and do not produce electromagnetic interference, and they suffer minimal signal degradation even over long cable lengths. They can also be used at higher temperatures compared to conventional sensors.

US2006/137467 A1 discloses a floating element shear-stress sensor using an optical Moiré transduction technique. The described setup utilises an optical microscope to interpret the shift in the Moiré fringe patterns. However, this results in a relatively bulky system, which may be difficult to implement in many applications.

US2011/0032512 A1 discloses a floating element shear-stress sensor in which the displacement of the floating element is detected through use of optical measurements. An optical fibre is positioned in proximity to the floating element to deliver the optical signal to the floating element, whilst another optical fibre in proximity to the floating element receives a reflected light signal.

US2018/0252600 discloses a MEMS capacitive wall shear stress vector measurement system, which is a capacitive device. Such capacitive devices can have drawbacks such as reliability at high temperatures and will likely suffer from electrical noise.

It is an object of the invention to provide a wall shear stress sensor having improved resolution whilst minimising size.

### SUMMARY OF THE INVENTION

According to a first aspect of the invention, there is provided a wall shear stress sensor comprising: a first optical grating; a second optical grating overlapping the first optical grating such that the first optical grating and second optical grating form a Moiré fringe pattern, wherein the second optical grating is displaceable relative to the first optical grating in response to a wall shear stress imparted on the sensor, and wherein displacement of the second optical grating correlates with a phase shift in the Moiré fringe pattern; an incident light source configured to sequentially illuminate a plurality of discrete locations distributed across the Moiré fringe pattern; and a photodetector configured to detect light intensity reflected from each discrete location on the Moiré fringe pattern.

According to a second aspect of the invention, there is provided a two-dimensional wall shear stress sensor system comprising: a first optical grating, and a second optical grating overlapping the first optical grating such that the first optical grating and second optical grating form a first Moiré fringe pattern, a third optical grating, and a fourth optical grating overlapping the third optical grating such that the third optical grating and fourth optical grating form a second Moiré fringe pattern; wherein the second optical grating is displaceable relative to the first optical grating in a first direction, and wherein displacement of the second optical grating correlates with a phase shift in the first Moiré fringe pattern; wherein the third optical grating is displaceable relative to the fourth optical grating in a second direction, and wherein displacement of the fourth optical grating correlates with a phase shift in the second Moiré fringe pattern; an incident light source configured to sequentially illuminate a plurality of discrete locations distributed across each of the first and second Moiré fringe patterns; and a first photodetector configured to detect light intensity reflected from each discrete location on the first Moiré fringe pattern, and a second photodetector configured to detect light intensity reflected from each discrete location on the second Moiré fringe pattern.

Certain aspects of the invention provide the advantage of more sensitive sensors with higher accuracy and resolution compared to previously known sensors.

Certain aspects of the invention provide the advantage of improved resolution in comparison to sensor size, enabling the production of smaller MEMS sensors without compromising on sensor resolution.

### BRIEF DESCRIPTION OF THE DRAWINGS

Embodiments of the invention are now described, by way of example only, hereinafter with reference to the accompanying drawings, in which:

FIG. 1. illustrates a wall shear stress sensor pad having a serpentine micro-spring arrangement;

FIG. 2. illustrates a section A-A of the wall shear stress sensor pad of FIG. 1;

FIG. 3. illustrates a wall shear stress sensor pad having a clamped micro-spring arrangement;

FIG. 4. illustrates the formation of a Moiré fringe pattern from two optical gratings;

FIG. 5a. illustrates an SEM image of a Moiré fringe pattern;

FIG. 5b.illustrates the reflected light intensity profile of the Moiré fringe pattern of FIG. 5a;

FIG. 6a. illustrates distribution of light spots across the Moiré fringe pattern;

FIG. 6b. illustrates the corresponding reflected light intensity of each light spot of FIG. 6b and the corresponding position on a fitted sine curve;

FIG. 7a. illustrates a wall shear stress sensor pad with the positioning of illuminated spots on the Moiré fringe pattern indicated;

FIG. 7b. illustrates modelling of the Moiré fringe pattern as a sinusoidal function;

FIG. 8. illustrates an example relationship between Moiré fringe pattern displacement, phase difference, and applied wall shear stress;

FIG. 9. illustrates an example wall shear stress sensor control unit system;

FIG. 10a. illustrates an example wall shear stress sensor packaging;

FIG. 10b. illustrates a sectional view of the wall shear stress sensor packaging of FIG. 10a;

FIG. 11a. illustrates an example two-dimensional wall shear stress sensor pad;

FIG. 11b. illustrates an SEM image of an example two-dimensional wall shear stress sensor pad;

FIG. 12a. illustrates probability density functions of fluctuating wall shear stress;

FIG. 12b. illustrates probability density functions of normalised fluctuating wall shear stress; and

FIG. 13. illustrates a dynamic calibration curve.

In the drawings, like reference numerals refer to like parts.

### DETAILED DESCRIPTION

Certain terminology is used in the following description for convenience only and is not limiting. For example, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

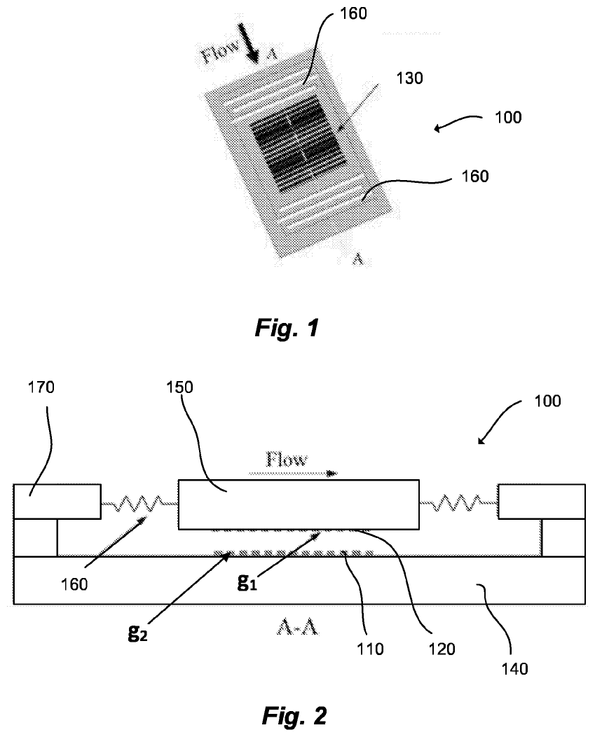

FIGS. 1 and 2 illustrate a wall shear stress sensor pad 100 of a wall shear stress sensor. The wall shear stress sensor may aptly be a micro-electro-mechanical-systems (MEMS) wall shear stress sensor. Such sensors typically have a sensor pad that is less than 1 mm in size at the largest dimension. In use, the sensor pad may be mounted substantially flush with a surface over which fluid flow passes.

The wall shear stress sensor pad 100 includes a first optical grating 110 and a second optical grating 120. The second optical grating 120 is positioned to overlap the first optical grating 110. In other words, the second optical grating 120 is superimposed over the first optical grating 110.

The overlapped first optical grating 110 and second optical grating 120 together form a Moiré fringe pattern 130. For example, as shown in FIG. 4, two optical gratings may have first and second differing pitches, g₁ and g₂. g₁ and g₂ may be selected according to the desired pitch, G, of the Moiré fringe pattern. For example, g₁ and g₂ may be around 3 to 4 microns and 7 to 8 microns respectively. In this example, g₁ is 3.75 microns and g₂ is 7.6 microns.

When the first and second optical gratings 110, 120 are superimposed with respect to each other, they form a Moiré fringe pattern having a pitch G. The relationship between the pitch of the Moiré fringe pattern and the pitch of each optical grating may be defined according to Equation 1:

$$\frac{1}{G} = \frac{1}{{g}_{1}} - \frac{1}{{g}_{2}}$$

The second optical grating 120 is displaceable relative to the first optical grating 110 in response to a wall shear stress imparted on the sensor pad 100. For example, a flow across the sensor pad in the direction indicated in FIGS. 1 and 2 will result in translational movement or displacement of the second optical grating 120 in the same direction as the flow. Displacement of the second optical grating 120 with respect to the first optical grating 110 results in a phase shift or displacement in the Moiré fringe pattern 130.

The displacement, a, of the Moiré fringe pattern 130 in relation to the physical displacement, d, of the second optical grating 130 may be defined according to Equation 2:

$$Δ = ( \frac{G}{{g}_{1}} ) δ$$

As such, wall shear stress forces imparted on the sensor 100 correlates with the phase shift in the Moiré fringe pattern 130. Measurement of the phase shift or displacement in the Moiré fringe pattern 130 thereby enables measurement of the wall shear stress imparted on the sensor 100.

The position of the Moiré fringe pattern 130 may be determined by measuring an intensity of light reflected therefrom. For example, an incident light source may illuminate a back side of the Moiré fringe pattern 130. Intensity of light reflected from the Moiré fringe pattern 130 may be measured by a photodetector. The “light” bands of the Moiré fringe pattern will reflect higher light intensity than the “dark” bands on the Moiré fringe pattern.

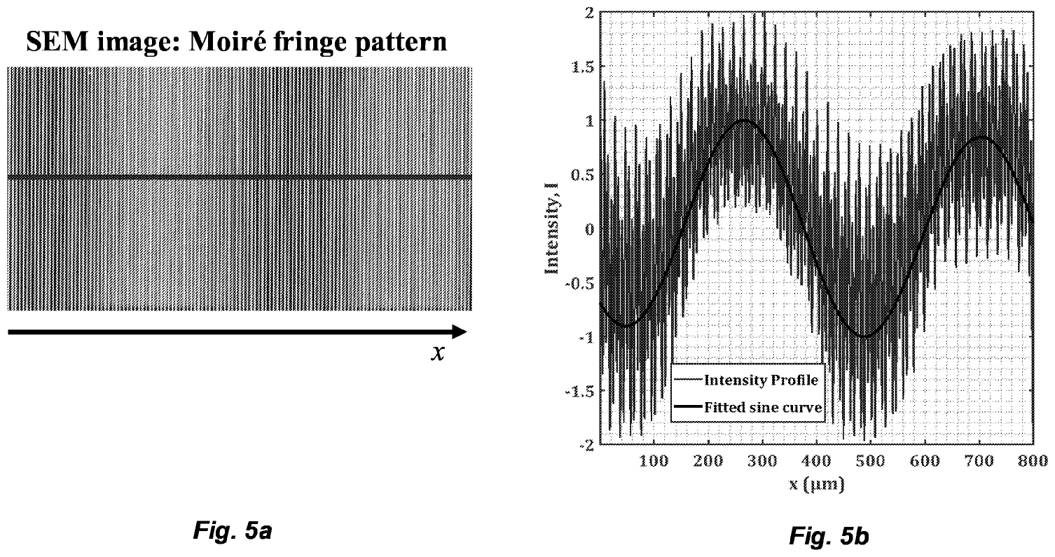

As illustrated in FIGS. 5a and 5b, the intensity of light reflected from the Moiré fringe pattern may be modelled as a sinusoidal function. A phase shift of the sinusoidal function is directly related to displacement of the second optical grating 120 and wall shear stress.

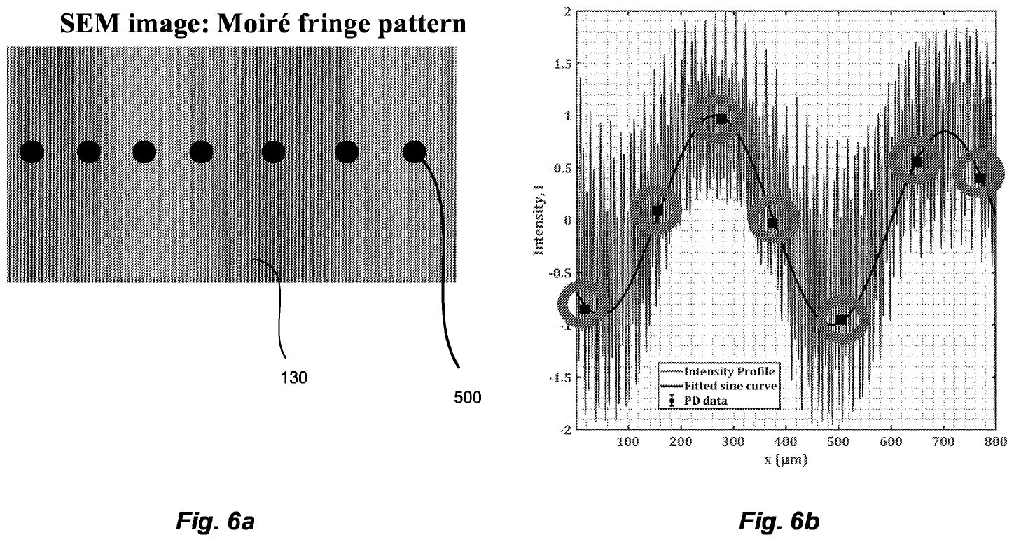

In this example, an incident light source is configured to sequentially illuminate a plurality of discrete locations distributed across the Moiré fringe pattern 130. That is, the incident light source is configured to sequentially project light onto a plurality of discrete locations distributed across the Moiré fringe pattern 130. Each discrete location is aptly spaced apart from an adjacent discrete location in the x direction as shown in FIG. 6a. In this way, each discrete location will correspond to a different point on the Moiré fringe pattern such that light reflected from each discrete location may have a different intensity depending on the position of the “light” and “dark” bands of the Moiré fringe pattern 130.

The incident light source is aptly positioned to project light onto a back side of Moiré fringe pattern 130. For the example shown in FIGS. 1 and 2, the incident light source may be positioned to project light through a transparent substrate 140 onto the Moiré fringe pattern 130.

A photodetector is configured to detect light intensity reflected from each discrete location on the Moiré fringe pattern 130. As illustrated in FIGS. 6a and 6b, intensity of light reflected from each of the discrete locations 500 can be mapped to reveal the sinusoidal response of the Moiré fringe pattern. In this way, the phase shift (or displacement) of the Moiré fringe pattern 130 over time, and therefore the displacement of the second optical grating 120 with respect to the first optical grating 110 can be determined.

As mentioned above, the incident light source is configured to sequentially illuminate a plurality of discrete locations distributed across the Moiré fringe pattern 130. Each of the discrete locations are aptly distributed across the Moiré fringe pattern in the x direction. That is, the discrete locations are distributed along the translational axis of the Moiré fringe pattern and the second optical grating 120.

Each discrete location is illuminated in sequence by the incident light source, forming a “ripple effect” across the Moiré fringe pattern. That is, each discrete location is illuminated individually whilst the other discrete locations remain non-illuminated. In this way, a first discrete location may be illuminated, followed by an adjacent discrete location, and then a next adjacent discrete location, and so on. Once all of the discrete locations have been illuminated individually, the sequence of illumination may repeat.

In other words, the incident light source is configured to ripple light “spots” across the Moiré fringe pattern, with each light spot being directed at a corresponding discrete location on the Moiré fringe pattern. The light spots are rippled in sequence, aptly at MHz frequency, to reveal the sinusoidal response of the Moiré fringe pattern.

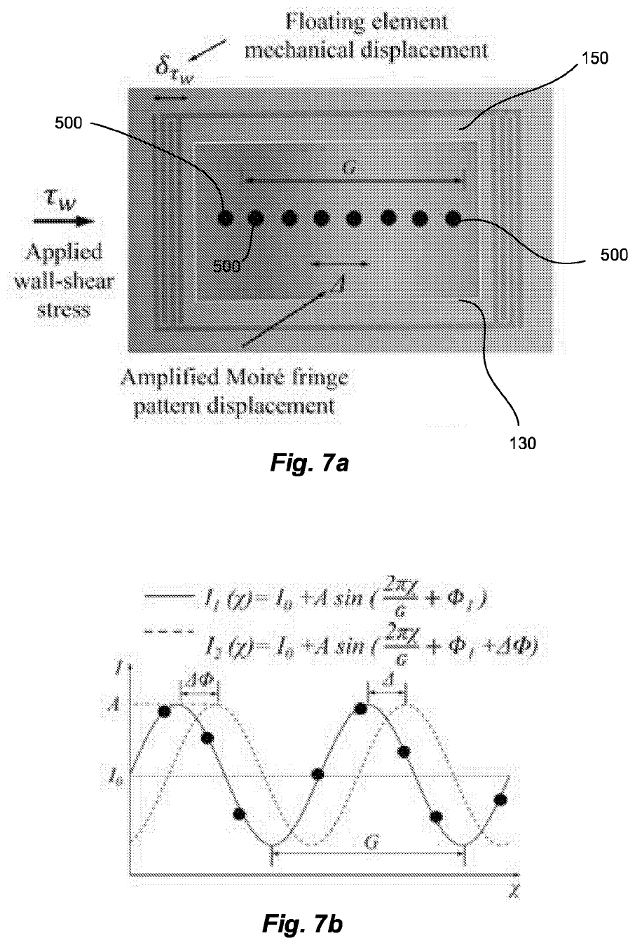

As the second optical grating displaces within air flow, for example, the phase of the sinusoidal response of the Moiré fringe pattern may be tracked with time by the photodetector. An example of this phase shift tracking is illustrated in FIGS. 7a and 7b.

As illustrated in FIGS. 6a and 7a, the incident light source may be configured to project a focussed light spot onto each discrete location 500. Each focussed light spot is aptly from order 1 micron to 100 microns in diameter, for example 10 to 20 microns, or 15 microns in diameter. The focussed light spot 500 may be produced through use of at least one of: one or more optical lenses, fibre optics or light sources.

The incident light source is aptly configured to sequentially illuminate the plurality of discrete locations at a frequency of at least one order of magnitude larger than the highest frequency content of the fluid flow to be detected. That is, for higher frequency fluid flow applications (e.g. aerospace applications) a higher frequency “rippling” of light spots will be desirable. For lower frequency fluid flow applications (e.g. low-speed measurements in a wind tunnel) a lower frequency rippling of light spots may be used. As such, the rippling frequency of the light spots may be determined according to the magnitude of frequency of the fluid flow to be detected. For example, the incident light source may be configured to sequentially illuminate the plurality of discrete locations at a frequency from 100 Hertz to 500 Megahertz.

Intensity of light reflected from the Moiré fringe pattern is detected using the photodetector. The photodetector is configured to detect light intensity reflected from each of the discrete locations on the Moiré fringe pattern. That is, the photodetector is positioned such that intensity of light reflected from each discrete location (corresponding to a light spot) may be detected by the photodetector.

In the example shown in FIG. 2, the photodetector may be positioned adjacent to the sensor pad 100 on the side of the transparent substrate 140. In this way, light reflected from the Moiré fringe pattern 130 may pass through the transparent substrate 140 to the photodetector.

The photodetector is aptly positioned to directly receive light reflected from the plurality of discrete locations on the Moiré fringe pattern. Since each discrete location is illuminated individually, the photodetector is able to detect intensity of light reflected from each discrete location individually. As such, this enables measurement of the position of the Moiré fringe pattern, since the light and dark bands of the Moiré fringe pattern directly relate to the intensity of reflected light. Alternatively, the photodetector may be positioned to indirectly receive light. For example, the photodetector could be located further away from the sensor pad, with the reflected light being transmitted to the photodetector by a fibre optic.

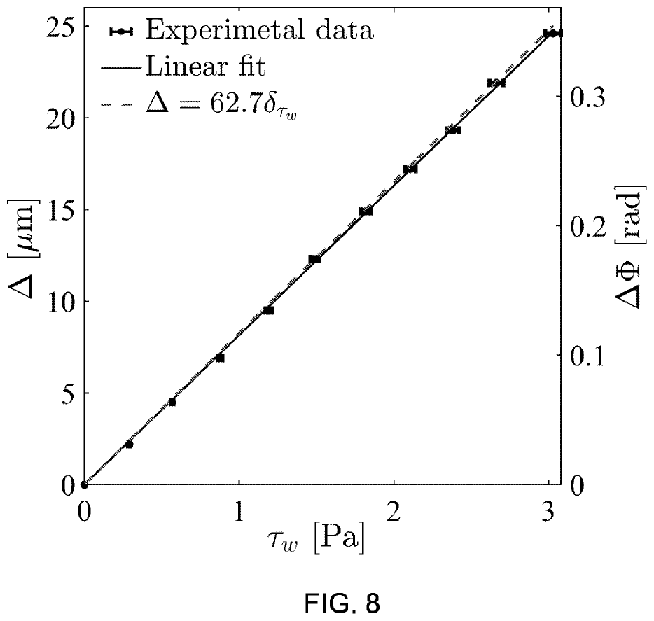

The phase change of the Moiré fringe pattern of the sensor 100 may be calibrated to allow direct mapping of instantaneous phase to instantaneous wall-shear stress. An example of the relationship between the displacement, Δ, of the Moiré fringe pattern 130, the phase difference, Δϕ, and the applied wall shear stress, τ_{w}, is illustrated in FIG. 8. As shown, the displacement of the Moiré fringe pattern is directly proportional to the applied wall shear stress.

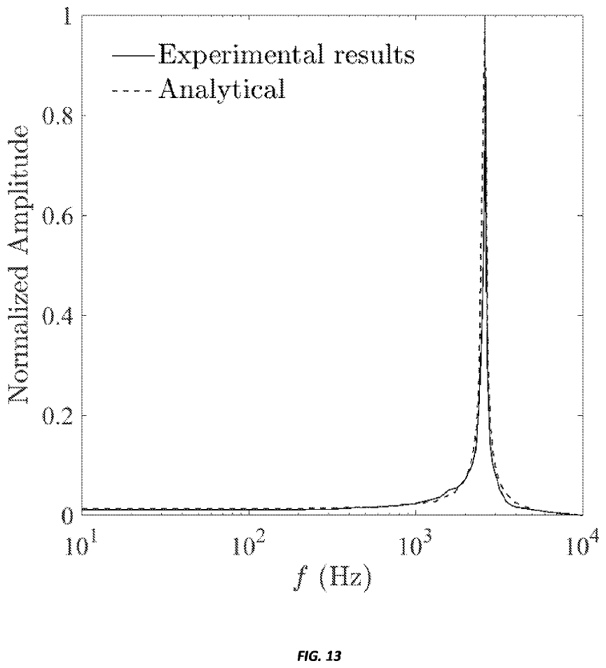

In FIG. 8, the dashed line is from an analytical expression developed to describe the sensor (described further below in relation to FIG. 13).

Referring back to FIGS. 1 and 2, the wall shear stress sensor pad 100 of this example is a MEMS device or “chip”. The MEMS device has a length and width on the order of 100 microns. In this example, the MEMS device is around 800 microns in width and 900 microns in length.

The sensor pad 100 includes the first and second optical gratings 110, 120. The sensor pad includes a substrate 140 supporting the first optical grating 110. That is, the first optical grating 110 may be disposed on a surface of the substrate. In this example, the first optical grating 110 is disposed on a surface of the substrate 140 which faces the second optical grating 120. The substrate 140 is aptly transparent such that incident and reflected light may pass therethrough. In this example, the substrate is formed from BF33 glass.

The substrate 140 is generally fixed such that it does not move in response to an applied shear-stress. For example, the substrate 140 may be fixed relative to an external surface (e.g. the surface of an object) at which fluid flow is to be measured. The fluid flow measured may be laminar flow, transitional flow or turbulent flow.

In this example, the wall shear stress sensor pad 100 further includes a floating element 150 supporting the second optical grating 120. That is, the second optical grating 120 may be disposed on a surface of the floating element 150. The floating element 150 is disposed in a plane substantially parallel to and spaced apart from the substrate 140. The floating element 150 and the substrate 140 are aptly spaced apart by 3 μm to 10 μm.

The first optical grating 110 and the second optical grating 120 are positioned in the same optical path. That is, the first optical grating 110 and the second optical grating 120 are superimposed such that incident light passing through the first optical grating 110 will pass through or reflect from the second optical grating 120.

The floating element 150 is configured for translational movement with respect to the substrate 140. In this way, the second optical grating 120 disposed on the floating element 150 may translate with respect to the first optical grating 110 disposed on the fixed substrate 140.

In this example, the floating element 150 is configured for translational movement along a single axis. For example, the floating element 150 is configured to translate back and forth along an axis corresponding to an x-axis of the Moiré fringe pattern 130. In this way, displacement of the floating element 150 may be seen as a phase shift in the Moiré fringe pattern 130.

The floating element may be formed from silicon, which is opaque.

The floating element 150 is mounted with respect to the substrate 140 via at least one micro-spring 160. The micro-spring 160 is configured to allow the translational movement of the floating element 150 with respect to the substrate 140.

The micro-spring 160 may extend between the floating element 150 and a support arm 170. The support arm 170 is fixed relative to the substrate 140. In this example, the support arm 170 extends substantially perpendicularly away from the substrate 140 towards the plane of the floating element 150.

In this example, the micro-spring 160 includes a first and second micro-spring each having a serpentine configuration. The first and second serpentine micro-springs are disposed at opposite ends of the Moiré fringe pattern and may stretch and compress upon translation of the floating element 150 with respect to the substrate 140. It will be appreciated by those skilled in the art that the properties of the serpentine micro-spring may be selected according to the desired properties and desired translational movement of the floating element under a given applied wall shear stress.

The serpentine micro-spring structure allows translation of the floating element 150 in a direction corresponding to a central axis passing through each micro-spring 160 either side of the Moiré fringe pattern 130. This is shown by the direction of flow indicated in FIG. 1.

Such serpentine type of micro-springs have not previously been used in one-dimensional wall shear stress sensors.

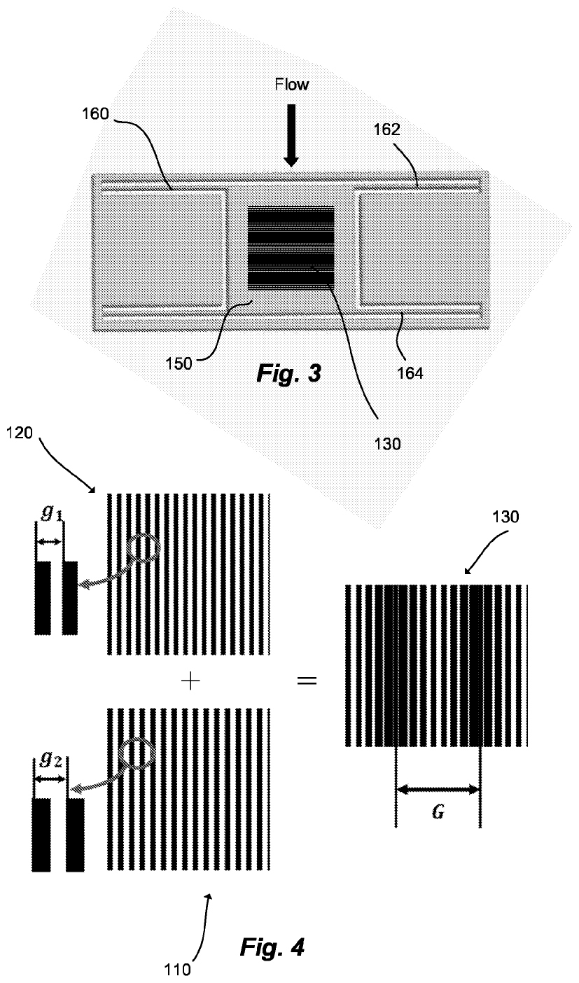

In another example, as shown in FIG. 3, the micro-spring 160 may include a clamped micro-spring disposed either side of the Moiré fringe pattern 130. That is, each clamped micro-spring is disposed adjacent to either the top or the bottom of the Moiré fringe pattern 130.

Each clamped micro-spring may include first and second elongate arms 162, 164 each fixed between the floating substrate 150 and a distal support that is fixed relative to the fixed substrate 140. In this example, each arm may have a width of around 7 microns. Again, it will be appreciated by those skilled in the art that the properties of the clamped micro-spring (e.g. the arm width and length) may be selected according to the desired properties and desired translational movement of the floating element 150 under a given applied wall shear stress.

The clamped micro-spring structure allows translation of the floating element 150 in a direction substantially orthogonal to the direction of extension of the elongate arms 162, 164. This is shown by the direction of flow indicated in FIG. 3.

In use, as fluid moves over the sensor pad, the floating element is free to move due to the micro-spring arrangement in the direction of the fluid flow whilst remaining parallel to the aero- or hydrodynamic surface in which the sensor is positioned. Since most industrial fluid flows of interest are turbulent, the floating element will oscillate back and forth, picking up chaotic motions of the fluid flow. Deflection of the floating element is very small, for example as low as tens of nanometres. Therefore, to detect the motion of the sensor the movement of the Moiré fringe pattern is tracked as described above. This helps to amplify the motion of the floating element by up to 120 times or more in the sensors described herein.

In FIG. 13, for a dynamic harmonic response curve, the analytical solution is derived from solving the following ordinary differential equation

M\ddot{x}+C\dot{x}+Kx=F₀ sin(ωt+ϕ)

in which

$$M = ρ {TW}_{e} {L}_{e}$$

$$C = \frac{μ {L}_{e} {W}_{e}}{{h}_{gap}}$$

$$K = 4 E {T [ \frac{{W}_{t}}{{L}_{t}} ]}^{3} [ \frac{1}{( 1 + \frac{2 {W}_{t} {L}_{t}}{{W}_{e} {L}_{e}} )} ]$$

and ω is the external applying force frequency.

In this example, the resonant frequency from the Zygo measurement is 2620 Hz and from the analytical modelling it is 2575 Hz. It can be seen that the analytical modelling using the above equation gives a resonant frequency result very close to the measured result. It can therefore be said that this is an excellent design tool, since it can be predicted exactly how a sensor will perform, both statically (FIG. 8) and dynamically (FIG. 13) in terms of sensor deflection, before it has been made. It can also be seen from the results shown in FIG. 13 that the sensors can be designed to pick up a large range of frequencies. Depending on the application, the range of the resonant frequency will vary.

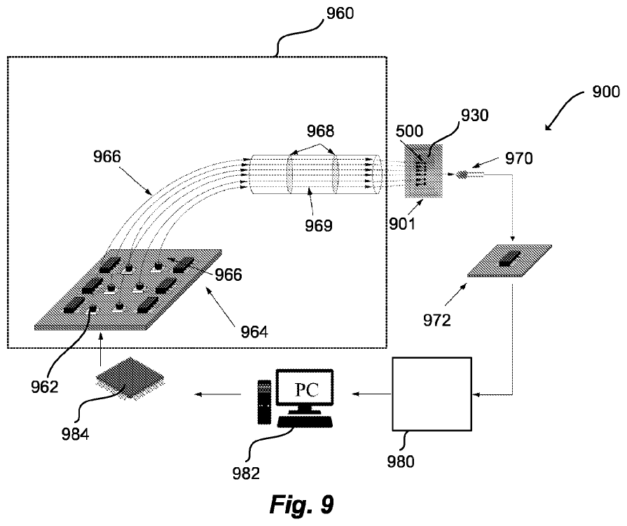

FIG. 9 illustrates an example of a wall shear stress detector system 900 including a wall shear stress sensor. As discussed above, the wall shear stress sensor includes a sensor pad 901 having first and second optical gratings overlapping to form a MEMS device with a Moiré fringe pattern 930.

An incident light source 960 is configured to sequentially illuminate a plurality of discrete locations 500 on the Moiré fringe pattern. That is, the incident light source 960 may be configured to project a plurality of light spots 500 on the Moiré fringe pattern. The plurality of light spots (and discrete locations) are distributed across the Moiré fringe pattern as discussed above in relation to FIGS. 6a and 7a.

In this example, the incident light source 960 includes a plurality of light sources 962. Each light source 962 is configured to illuminate one of the plurality of discrete locations 500 distributed across the Moiré fringe pattern. That is each light source 962 is configured to project a single light spot onto the Moiré fringe pattern, with each light spot corresponding to one of the discrete locations. Specifically, this example includes six light sources, which are configured to illuminate six corresponding discrete locations 500 on the Moiré fringe pattern 130.

In this example, each light source 962 is an LED integrated into a light source drive circuit 964. The incident light source 960 includes a fibre optic cable 966 extending from each light source 962 (LED) to direct light towards a corresponding discrete location 500 on the Moiré fringe pattern 930.

In this example, the incident light source 960 also includes first and second optical lenses 968. For example, the first and second optical lenses may include a pair of aspheric condenser lenses.

The first and second optical lenses 968 are positioned between the plurality of light sources 962 and the Moiré fringe pattern and are configured to focus light from the plurality of light sources 962 onto the discrete locations 500 as focussed light spots. In this example, the optical lenses 968 are positioned between the fibre optic cables 966 and the Moiré fringe pattern 930. In this way, the optical lenses are positioned to focus light from the fibre optic cables 966 such that it is projected onto the Moiré fringe pattern 930 as a focussed light spot. Spacing 969 between the first and second lenses 968 may be variable to adjust the diameter of the light spot projected onto the Moiré fringe pattern 930.

A photodetector 970 is configured to detect light intensity reflected from each discrete location 500 on the Moiré fringe pattern 930. In this example the sensor includes a single photodetector 970 positioned relative to the Moiré fringe pattern, such that light reflected from any of the discrete locations 500 may be detected.

As discussed above, the photodetector is positioned to directly receive light reflected from the plurality of discrete locations on the Moiré fringe pattern. Since each discrete location is illuminated individually, the photodetector is able to detect intensity of light reflected from each discrete location individually. As such, this enables measurement of the position of the Moiré fringe pattern, since the light and dark bands of the Moiré fringe pattern directly relate to the intensity of reflected light.

The photodetector 970 detects reflected light and outputs a signal, which is indicative of detected light intensity. That is, the amplitude of the output signal corresponds to the reflected light intensity of the scanned point on the Moiré fringe pattern, and its phase signifies the position of the dark and light bands.

The system 900 may further include a photo-detector amplifier circuit 972 for amplifying the signal from the photodetector, a processor 980, a PC 982, and a micro-controller 984 for controlling the light source drive circuit 964.

The processor 980 is configured to receive a signal from the photodetector 970, which is indicative of detected light intensity at each discrete location and analyse the received data to determine a shape and position of the Moiré fringe pattern. For example, the sinusoidal response of the Moiré fringe pattern may be determined.

The processor may then calculate the phase shift of the Moiré fringe pattern and use this to determine displacement of the second optical grating with respect to the first optical grating and the corresponding wall shear stress imparted on the sensor.

In use, a rippling light from the plurality of LEDs 962 in the drive board 964 is launched down the corresponding fibre optic cable 966 and is then focussed on the back side of the Moiré fringe pattern 930, via the lenses 968, to a small spot of light at the discrete location 500. The spot of light is typically in the order of 10 microns in diameter, depending on the size of the floating element and Moiré fringe pattern 930. The projected light spots are rippled in sequence at different frequencies from around 100 Hz to MHz depending on the flow speed to reveal the sinusoidal response of the Moiré fringe pattern 930.

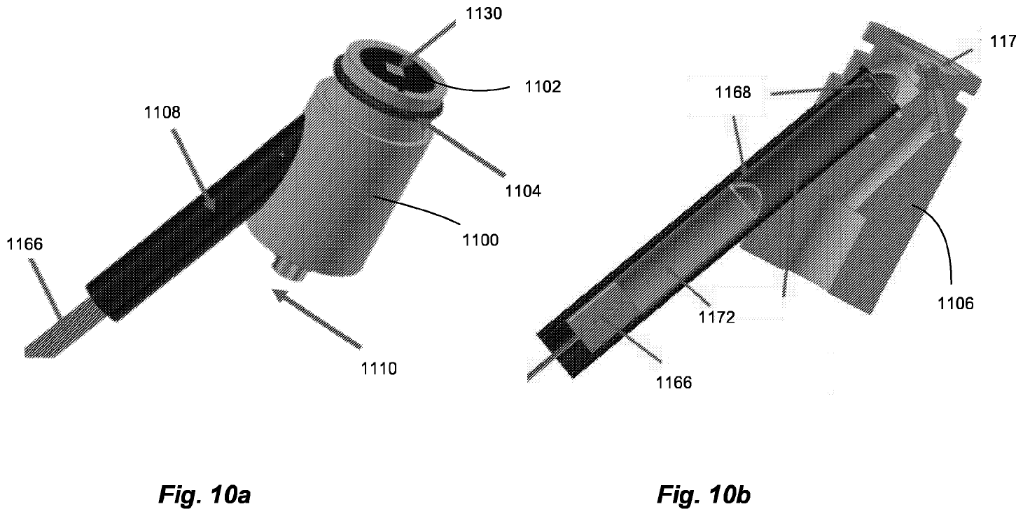

FIGS. 10a and 10b illustrates an example of sensor packaging.

Here, each of the sensor components are embedded in a housing 1100. The housing includes a sensor surface 1102 on which the sensor pad including the Moiré fringe pattern 1130 is disposed. In use, the sensor surface 1102 may be arranged to be flush with a surface of an object for which wall shear stress is to be measured. As such, turbulent flow over the surface of the object will impart a shear-stress to the floating element of the sensor pad and result in a phase shift in the Moiré fringe pattern as described above.

An O-ring seal 1104 may be positioned around the surface 1102 to provide a seal against the surface of the object for which wall shear stress is to be measured and prevent fluid ingress into internal components of the sensor.

The housing 1100 further includes a main housing body 1106 configured to house the photodiode 1170. As shown in FIG. 10b, the photodiode 1170 is positioned behind the Moiré fringe pattern 130 so as to detect light reflected therefrom. The main housing body 1106 includes a sensor output 1110 for output of the electronic signal from the photodiode 1170.

The housing also includes an elongate housing portion 1108 extending from the main housing body 1108. The elongate housing portion 1108 is configured to house the optical components of the sensor, including the fibre optic cables 1166 and the optical lenses 1168. This example also includes a first and second spacer 1172.

The first spacer 1172 is positioned between the fibre optic cables and the lenses 1168 and the second spacer is positioned between the lenses 1168.

The fibre optic cables may be in communication with a light source, for example an LED, as described above in relation to FIG. 9. As shown in FIG. 10b, the lenses 1168 and fibre optic cables 1166 are positioned such that light from the light source can be directed along the fibre optic cables 1166, and focused via the lenses 1168 onto a back side of the Moiré fringe pattern 1130.

Various modifications to the detailed arrangements as described above are possible without departing from the scope of the claims.

Although the examples above relate generally to a one-dimensional sensor configured to measure wall shear stress along a single direction, the sensor may also be configured as a two-dimensional sensor configured to measure wall shear stress in two directions.

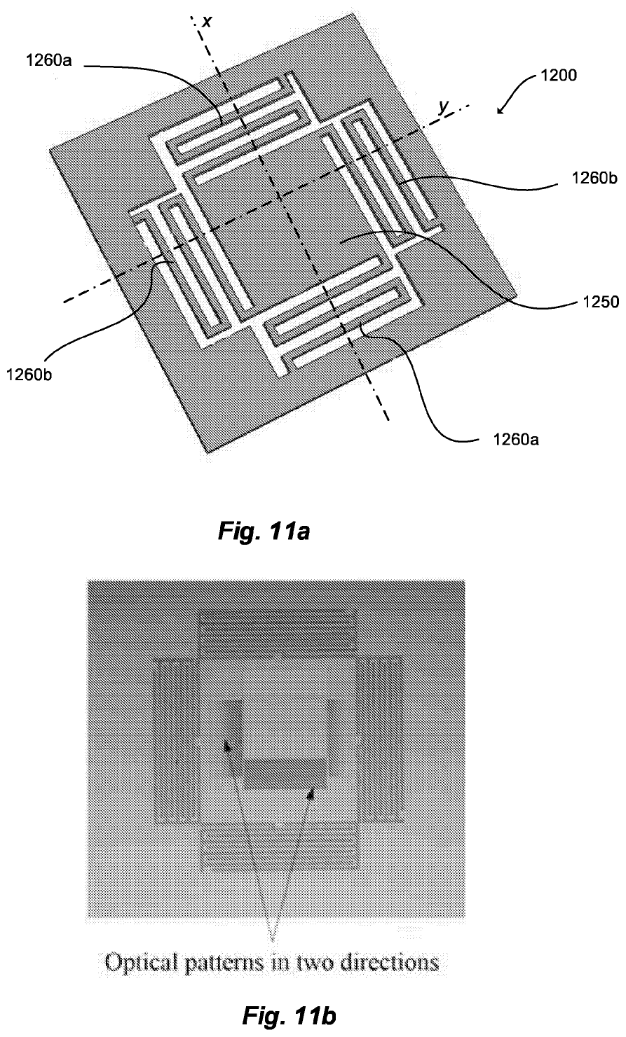

For example, FIG. 11a illustrates a sensor pad 1200 in which the floating element is configured to translate in a first and second direction. The sensor pad 1200 may be configured similarly to those described above in relation to FIGS. 1 to 3, for example. However, in this example, the floating element is supported by two pairs of micro-springs 1260a, 1260b. The first pair of micro-springs 1260a allow translational movement of the floating element 1250 in a first direction, x. The second pair of micro-springs 1260b allow translational movement of the floating element 1250 in a second direction, y. In this example, the first direction, x, is substantially perpendicular to the second direction, y. The micro-springs 1260a, 1260b may include any suitable configuration to allow translational movement of the floating element. In this example each of the micro-springs are serpentine micro-springs.

FIG. 11b illustrates an SEM image of a sensor pad having the micro-spring configuration of FIG. 11a. As shown, the sensor pad includes Moiré fringe patterns oriented in two directions corresponding to the directions of translation of the floating element. In this example, the sensor pad includes four separate Moiré fringe patterns, with two Moiré fringe patterns oriented in each direction. However, it will be appreciated that other Moiré fringe pattern configurations may be possible, with at least one Moiré fringe pattern oriented in each of the first and second directions.

Corresponding optoelectronics may be included in the sensor for each Moiré fringe pattern on the sensor pad. For example, the incident light source may be configured to sequentially illuminate a plurality of discrete locations on each of the Moiré fringe patterns and a photodetector may be provided to detect light intensity reflected from each Moiré fringe pattern.

Aptly, the incident light source may be configured to illuminate Moiré fringe patterns oriented in a first direction with light having a first wavelength, and may be configured to illuminate Moiré fringe patterns oriented in a second direction with light having a second wavelength different to the first wavelength. Similarly, a first photodetector may be provided to detect light intensity reflected from Moiré fringe patterns oriented in the first direction, and a second photodetector may be provided to detect light intensity reflected from Moiré fringe patterns oriented in the second direction. In this way, the first photodetector may be configured to detect light having the first wavelength and the second photodetector may be configured to detect light having the second wavelength. Optional optical filters may be used in conjunction with the photodetectors such that only the relevant wavelength of light is detected. As such, each photodetector can accurately detect reflected light associated with Moiré fringe patterns oriented in a single direction, thereby avoiding noise of light reflected from Moiré fringe patterns oriented in the other direction.

Although in the examples described above, the incident light source includes six LEDs and is configured to project six light spots onto six corresponding discrete locations on the Moiré fringe pattern, it will be appreciated that the incident light source may be configured to project other numbers of light spots onto corresponding discrete locations on the Moiré fringe pattern. For example, the incident light source may be configured to illuminate at least two discrete locations, or from 2 to 10 discrete locations or aptly 4 to 6 discrete locations on the Moiré fringe pattern. As described above, an optical cable may be provided for each light source to help direct the light to the corresponding discrete location on the Moiré fringe pattern.

Although LEDs are shown in the example above, the incident light source may include other types of light source including coherent or non-coherent light sources. For example, the incident light source may include a non-coherent light source including at least one of LEDs, OLEDs, QLEDs. In other examples, the incident light source may include a coherent light source, for example one or more laser light sources. Coherent light sources may have the advantage of enabling more focussed light spots, which may help to increase the accuracy or resolution of the sensors. Furthermore, coherent light sources may be used without optical lenses for focussing the light, thereby potentially allowing for a reduced size sensor.

Although the system described above in relation to FIG. 9 includes fibre optic cables to help direct the light to the Moiré fringe pattern, in other examples, the fibre optic cables may be omitted. For example, it may be possible to position the light source to directly illuminate the corresponding discrete location on the Moiré fringe pattern.

Whilst example dimensions have been provided above for the diameter of the focussed light spots which are projected onto the discrete locations, it will be appreciated that different size light spots may be utilised. The diameter of the light spots may aptly be selected dependent on the side of the floating element. The size of the light spots may optionally be adjusted through the use of optical lenses. For example, the distance between two optical lenses may be adjusted to adapt the size of the light spots projected onto the Moiré fringe pattern. In this way, the size and position of the projected light spots may be fine-tuned so that they are distributed across the whole width of the Moiré fringe pattern.

Whilst the example above include a single photodetector configured to detect light reflected from each of the discrete locations, it will be appreciated that it may be possible to include one or more photodetectors each positioned to detect light reflected from one or more of the discrete locations. However, it may be preferable to use a single photodetector in order to minimise the size of the sensor and simplify the optoelectronic configuration.

The optical gratings described above may be fabricated in various ways. For example, the optical gratings may include patterning gold on the silicon and BF33 substrate using lithography and lift-off processes.

The sensor resolution of the above described sensors may be up to twice as good as other commercially available sensors. In terms of size-for-size comparison, the resolution of the above-described sensors may be up to 40 times better compared to optical sensors of comparable size.

By rippling the light across each of the discrete locations as described above, the photodetector is able to more accurately detect light reflected from only one discrete location at a time. This helps to mitigate the drawbacks of illuminating all of the discrete locations together since this approach would require multiple photodetector for each discrete location and would risk crosstalk since light reflected from one location could “spill out” and be detected by the wrong photodetector.

The above described sensors mitigate the need to use fibre optics bundles to direct reflected light out of the sensor. By mounting the photodetector directly behind the Moiré fringe pattern, the sensor does not suffer any losses of light passing through a fibre optic cable. This helps to improve the resolution and accuracy of the sensor.

The use of serpentine micro-springs as described above may help to improve the response of the floating element. This coupled with the rippling optoelectronics results in more sensitive sensors with higher accuracy and resolution, particularly in a MEMS wall shear stress sensor.

The sensors described herein have a further advantage that they do not suffer from electrical noise and maintain performance in a wide range of temperatures, in particular high temperatures.

### EXAMPLES

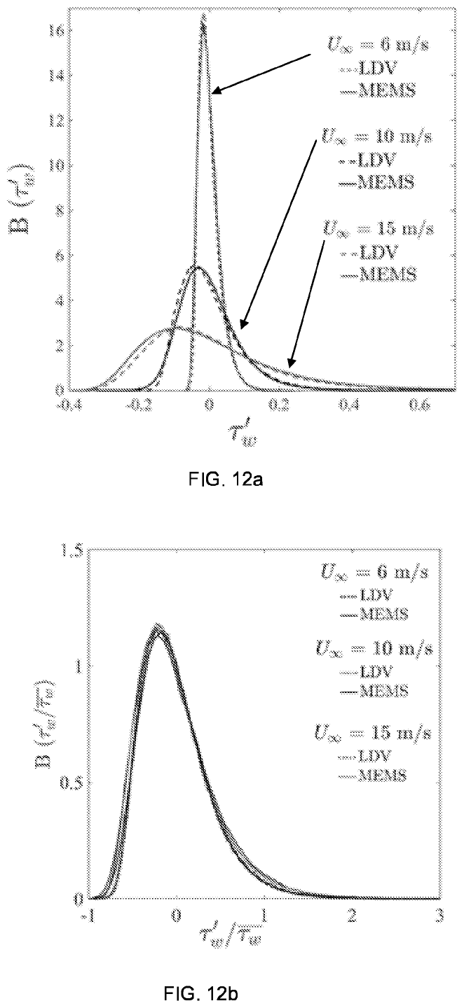

FIGS. 12a and 12b illustrate experimental results from wind tunnel tests. Here the sensor of the present invention is implemented inside the wind tunnel to measure the turbulent flow alongside a commercially available technique—Laser Doppler velocimetry (LDV). The LDV probe is positioned within the viscous sublayer to measure fluctuating wall shear stress. The LDV probe and the MEMS sensor data is acquired simultaneously. FIG. 12a shows probability density functions of fluctuating wall shear stress for U_{∞}=6 m/s, U_{∞}=10 m/s, and U_{∞}=15 m/s, measured by LDV (dashed lines) and MEMS sensor (solid lines). FIG. 12b shows probability density functions of normalized fluctuating wall shear stress for U_{∞}=6 m/s, U_{∞}=10 m/s, and U_{∞}=15 m/s, measured by LDV (dots) and MEMS sensor (solid lines). The results in FIGS. 12a and 12b can be interpreted as follows. The MEMS sensor and LDV data collapse (i.e. the results from the MEMS sensor follow the results from the LDV extremely closely), validating that the MEMS sensor accurately captures the instantaneous wall shear stress fluctuations of the turbulent flow, noting that the accuracy of LDV is within c. 1%.

The MEMS sensors allow a direct measurement of wall shear stress; LDV is an indirect measurement of wall shear stress where the LDV probe is positioned within the viscous sublayer of the flow. The viscous sublayer is typically a few hundred microns thick and is the region closest to the wall. Here, the LDV system measures the velocity within the viscous sublayer, which is transformed into wall shear stress by invoking Newton's law of viscosity. An LDV system is large and expensive, allowing measurement at a single location. Further, as the Reynolds number increases, the thickness of viscous sublayer decreases, such that, eventually, the LDV probe would no longer fit within the viscous sublayer, and thereby would no longer be able to be used to measure the wall shear stress. In contrast, the MEMS sensors remain fully functional up to high Reynolds number fluid flows.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A wall shear stress sensor comprising:
a first optical grating;
a second optical grating overlapping the first optical grating such that the first optical grating and second optical grating form a Moiré fringe pattern, wherein the second optical grating is displaceable relative to the first optical grating in response to a wall shear stress imparted on the sensor, and wherein displacement of the second optical grating correlates with a phase shift in the Moiré fringe pattern;
an incident light source configured to sequentially illuminate a plurality of discrete locations distributed across the Moiré fringe pattern; and
a photodetector configured to detect light intensity reflected from each discrete location on the Moiré fringe pattern.

2. A wall shear stress sensor according to claim 1, further comprising a substrate supporting the first optical grating.

3. A wall shear stress sensor according to claim 1, wherein the first optical grating is fixed.

4. A wall shear stress sensor according to claim 2, further comprising a floating element supporting the second optical grating.

5. A wall shear stress sensor according to claim 4, wherein the floating element is configured for translational movement with respect to the substrate.

6. A wall shear stress sensor according to claim 5, further comprising at least one micro-spring configured to allow translational movement of the floating element with respect to the substrate.

7. A wall shear stress sensor according to claim 6, wherein the micro-spring is a clamped micro-spring or a serpentine micro-spring.

8. A wall shear stress sensor according to claim 1, wherein the first and second optical grating are positioned in the same optical path.

9. A wall shear stress sensor according to claim 1, wherein the incident light source is configured to sequentially illuminate the plurality of discrete locations at a frequency of from 100 Hertz to 500 Megahertz.

10. A wall shear stress sensor according to claim 1, wherein the incident light source is configured to project a focussed light spot onto each discrete location.

11. A wall shear stress sensor according to claim 10, wherein the focussed light spot is from order 1 micron to order 100 microns in diameter.

12. A wall shear stress sensor according to claim 1, wherein the incident light source comprises a plurality of light sources, each light source configured to illuminate one of the plurality of discrete locations distributed across the Moiré fringe pattern.

13. A wall shear stress sensor according to claim 12, wherein each of the plurality of light sources is either coherent or incoherent.

14. A wall shear stress sensor according to claim 12, wherein the incident light source further comprises a fibre optic cable extending from each light source to direct light towards a corresponding discrete location on the Moiré fringe pattern.

15. A wall shear stress sensor according to claim 12, wherein the incident light source further comprises at least one optical lens positioned between the plurality of light sources and the Moiré fringe pattern and configured to focus light from the plurality of light sources onto the plurality of discrete locations.

16. A wall shear stress sensor according to claim 1, wherein the photodetector is positioned to directly receive light reflected from the plurality of discrete locations on the Moiré fringe pattern.

17. A wall shear stress sensor according to claim 1, wherein an output from the photodetector is indicative of detected light intensity.

18. A wall shear stress sensor according to claim 1, wherein the wall shear stress sensor is a micro-electro-mechanical-system wall shear stress sensor.

19. A two-dimensional wall shear stress sensor system comprising:
a first optical grating, and a second optical grating overlapping the first optical grating such that the first optical grating and second optical grating form a first Moiré fringe pattern,
a third optical grating, and a fourth optical grating overlapping the third optical grating such that the third optical grating and fourth optical grating form a second Moiré fringe pattern;
wherein the second optical grating is displaceable relative to the first optical grating in a first direction, and wherein displacement of the second optical grating correlates with a phase shift in the first Moiré fringe pattern;
wherein the third optical grating is displaceable relative to the fourth optical grating in a second direction, and wherein displacement of the fourth optical grating correlates with a phase shift in the second Moiré fringe pattern;
an incident light source configured to sequentially illuminate a plurality of discrete locations distributed across each of the first and second Moiré fringe patterns; and
a first photodetector configured to detect light intensity reflected from each discrete location on the first Moiré fringe pattern, and
a second photodetector configured to detect light intensity reflected from each discrete location on the second Moiré fringe pattern.

20. A two-dimensional wall shear stress sensor according to claim 19, wherein the incident light source is configured to sequentially illuminate the plurality of discrete locations on the first Moiré fringe pattern with light having a first wavelength and illuminate the plurality of discrete locations on the second Moiré fringe pattern with light having a second wavelength different to the first wavelength.

21. A two-dimensional wall shear stress sensor according to claim 20, wherein the first photodetector is configured to detect only light having the first wavelength and the second photodetector is configured to detect only light having the second wavelength.

22. A wall shear stress detector system comprising the wall shear stress sensor according to claim 1, the system further comprising a processor, wherein the processor is configured to:
receive a signal from the photodetector indicative of detected light intensity at each discrete location;
analyse the received data to determine a shape and position of the Moiré fringe pattern; calculate, from the shape and position, a phase shift of the Moiré fringe pattern; and
determine, using the calculated phase shift, a displacement of the second optical grating with respect to the first optical grating and a corresponding wall shear stress imparted on the sensor.

23. A method of measuring wall shear stress using the wall shear stress sensor according to claim 1, the method comprising:
analysing the detected light intensity to determine a shape and position corresponding to the Moiré fringe pattern;
calculating, from the shape and position, a phase shift of the Moiré fringe pattern; and
determining, using the calculated phase shift, a displacement of the second optical grating with respect to the first optical grating and a corresponding wall shear stress imparted on the sensor.

24. A computing device comprising a processor configured to carry out the method according to claim 23.

25. A machine-readable storage medium storing a computer program comprising instructions arranged, when executed, to implement the method of claim 23.
